(19) United States
(12) Patent Application Publication
(10) Pub. No.: US 2026/0061809 A1
(43) Pub. Date: Mar. 5, 2026

(54) Tarp Cover System

(71) Applicant: Tarpstop, LLC, Toledo, OH (US)

(72) Inventors: Justin Bjorum, Wyoming, MI (US); Aaron Vail, Grand Rapids, MI (US)

(73) Assignee: Tarpstop, LLC, Toledo, OH (US)

(21) Appl. No.: 18/824,094

(22) Filed: Sep. 4, 2024

(51) Int. Cl. B60J 7/08; B65D 88/12

(52) U.S. Cl. CPC B60J 7/085; B65D 88/125

(57) ABSTRACT

A cover drive system comprises a flexible cover or tarp, a front cover arm, a rear cover arm, and a towel bar. The front cover arm includes first and second sections connected together by a flex member. A drive system is attached to the front cover arm and is configured to deploy and retract a tarp cover. The drive system includes a transmission with a disconnect that permits manual operation of the tarp covering system without removing the drive motor. The rear cover arm includes a rear flex member that permits normal operation of a rear trailer end panel when configured as a hinged tailgate or door. The tarp is supported by a plurality of bows that can accommodate relative movement of trailer side walls during operation. In certain embodiments, the rear cover arm may be substituted with a tarp tensioner. The tarp tensioner includes a tensioning assist spring and block-and-tackle to assist in retracting the tarp from a deployed state.

### BACKGROUND OF THE INVENTION

This invention relates in general to covering systems used in trailer hauling applications. In particular, this invention relates to a power actuated top covering system for selectively covering the open top area of a trailer having rigid side walls.

Commercial truck trailers are produced in a variety of forms to support and haul a variety of goods. Flatbed trailers are designed to haul heavy loads, such as coiled steel or larger pieces of equipment, and permit these loads to be placed on the trailer surface easily. Box trailers tend to haul lighter packaged goods that need to be protected from wind loads during transport. Open top, dump trailers configured to haul generally loose and dry goods, such as grain, sand, gravel, and the like, have generally rigid side walls and a rear mounted gate, bottom-mounted chute, or door. The open top permits the goods to be loaded into the trailer. The gate permits goods to be released as the trailer is tilted. The bottom-mounted door permits unloading without the need to tilt the trailer.

Open top dump trailers, because of the loose nature of their cargo, are often covered to prevent road wind from blowing the trailer contents onto the roadway and onto other vehicles following behind. Many states require certain types of loose cargo to be covered to prevent debris from impacting other vehicles. These top coverings may be canvas or rigid panels. Canvas coverings are usually rolled, either to one side or an end of the trailer, to deploy or remove the cover. Despite the covering systems that exist, they each have drawbacks.

Thus, it would be desirable to provide a cover system for an open top trailer that improves deployment and durability.

### SUMMARY OF THE INVENTION

This invention relates to a cover system comprising a flexible cover or tarp configured to span an open top of a trailer. The trailer has a front end panel, a rear end panel, a first sidewall and a second sidewall extends between the front end panel and the rear end panel. A front pivot bracket and front mounting bracket are configured to attach the front cover arm to the front end panel of the trailer. The front cover arm includes first and second sections connected together by a flex member. The flex member is configured as a polymer, corrugated outer tube filled with a urethane core material. A drive system is removably mounted to the end of the front cover arm to engage with a towel bar and tarp assembly. The drive system has a motor driving a transmission that includes a disconnect between drive system input and output. A rear pivot bracket and rear mounting bracket are configured to attach a rear cover arm to the rear end panel of the trailer. The rear cover arm includes a first section and a towel bar coupler connected together by a flex member. A towel bar extends between the front end cover arm and the rear cover arm.

In certain aspects of the invention, a tarp cover system comprises a front cover arm, a drive system, and a towel bar. The front cover arm has a first section joined to a second section by a flex member. The drive system is supported by the second section of the front cover arm and has a drive motor operatively connected to a transmission. The transmission includes a disconnect assembly that selectively engages or disengages a transmission output from a transmission input. The towel bar engages the transmission output to deploy or retract a trailer tarp cover relative to a trailer body.

The transmission includes a disconnect actuator engaging a disconnect collar configured to separate a drive gear from a driven gear within the transmission. The disconnect actuator may include a threaded shaft engaged with the disconnect collar. In certain configurations, the first section includes a flange that secures the drive system thereto, the drive system being axially moveable relative to the flange and detachable from the flange independently of the front cover arm. The flange may be configured to engage a transmission housing that supports the drive motor. The flex member may be configured as a corrugated outer sleeve filled with a core material, where the corrugated outer sleeve may be formed from one of polyethylene or polypropylene material. In certain aspects, the core material may be a flexible foam material formed from one of a urethane or a latex foam having a durometer in a range of about 70 Shore A scale to about 90 Shore A scale. The core material may also include an access port extending therethrough, the access port configured to accommodate an electrical harness.

The tarp cover system may include a rear cover arm that engages the towel bar. The rear cover arm may include a first section and a second section connected together by a flex member. The rear arm may further include a disconnect coupling configured to permit the first section to be removed from the second section. The disconnect coupling can be attached to the rear cover arm flex member and may include a disconnect collar configured to align and attach to the first section and a lockdown strap connected between the disconnect collar and the first section. In certain embodiments, the tarp cover system may include a tarp tensioner in place of the rear cover arm. The tarp tensioner may be configured to engage a manual drive end of the towel bar and include a tension assist spring and a tension multiplier. The tension multiplier may be a block-and-tackle pulley and cable system having a fixed block attached to a housing and a moving block connected to the assist spring. A return cable is attached to the manual drive end at a first end, roved through the fixed and moving blocks, and attached to the moving block at a second end.

In certain other embodiments, the tarp cover system includes a plurality of length-adjustable bows attached to side walls of the trailer body. The length-adjustable bows accommodate relative movement of the side walls and support the tarp covering between a retracted position and a deployed position. The length-adjustable bows each include angle struts attached to the trailer side walls. The angle struts have slide arms that engage a cross tube over a telescoping interface to permit relative movement between the slide arms and the cross tube. In certain aspects, the cross tube is hollow and the telescoping interface is configured as a generally straight section. The slide arms engage a cross tie that extends through the cross tube.

A trailer and tarp cover system comprises a front cover arm, a rear cover arm, and a towel bar connecting therebetween. A drive system is supported by the second section of the front cover arm, the drive system having a drive motor operatively connected to a transmission, the transmission including a disconnect assembly that selectively engages or disengages a transmission output from a transmission input. The front cover arm is mounted to a front end of the trailer and having a first section joined to a second section by a front arm flex member. The rear cover arm is mounted to a rear end panel of the trailer. The rear cover arm includes a first section and a second section connected together by a rear arm flex member. The rear arm flex member attaches to the first section by a disconnect coupling that includes a disconnect collar configured to align with the first section and a lockdown strap connected between the disconnect collar and the first section.

In certain embodiments, the trailer and tarp cover system includes a plurality of length-adjustable bows that are attached to side walls of the trailer. The bows accommodate relative movement of the side walls and support the tarp covering between a retracted position and a deployed position. The length-adjustable bows include angle struts attached to the trailer side walls. The angle struts have slide arms that engage a cross tube over a telescoping interface permitting relative movement between the slide arms and the cross tube.

In another aspect of the invention, a trailer and tarp cover system comprises a front cover arm and drive system, a tarp tensioner, and a towel bar. The front cover arm is mounted to a front end of the trailer and having a first section joined to a second section by a front arm flex member. The drive system is supported by the second section of the front cover arm, the drive system having a drive motor operatively connected to a transmission, the transmission including a disconnect assembly that selectively engages or disengages a transmission output from a transmission input. The towel bar connects to the front cover arm and has a manual drive end extending toward a rear end panel of the trailer, the towel bar is configured to deploy or retract a trailer tarp cover relative to the trailer. The tarp tensioner is mounted to the rear end panel of the trailer and configured to engage a manual drive end of the towel bar. The tarp tensioner includes a tension assist spring and a tension multiplier, configured as a block-and-tackle pulley and cable system having a fixed block attached to a housing and a moving block connected to the assist spring. A return cable is attached to the manual drive end at a first end, roved through the fixed and moving blocks, and attached to the moving block at a second end.

The trailer and tarp cover system further includes a plurality of length-adjustable bows that are attached to side walls of the trailer and accommodate relative movement of the side walls. The length-adjustable bows support the tarp covering between a retracted position and a deployed position and include angle struts attached to the trailer side walls. The angle struts have slide arms that engage a cross tube over a telescoping interface permitting relative movement between the slide arms and the cross tube.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a side elevation view of a trailer having a cover drive system according to the invention.

FIG. 2 is a perspective view of the trailer and the cover drive system illustrated in FIG. 1.

FIG. 3 is an elevation view of a front end panel of the trailer and cover drive system illustrated in FIG. 1.

FIG. 4 is an elevation view of a rear end panel of the trailer and cover drive system illustrated in FIG. 1.

FIG. 5A is a perspective view of a front cover arm of the cover drive system illustrated in FIG. 3.

FIG. 5B is an enlarged, cross sectional view of a flex member of the front cover arm of FIG. 5A.

FIG. 6 is a perspective view of a power drive system of the cover drive system illustrated in FIG. 1.

FIG. 7 is a perspective, cross sectional view of the drive system of FIG. 6.

FIG. 8 is an exploded view of the drive system illustrated in FIG. 6.

FIG. 9A is a perspective view of a rear cover arm of the cover drive system illustrated in FIG. 4.

FIG. 9B is an enlarged, perspective view of a towel bar coupling of the rear cover arm of FIG. 9A.

FIG. 9C is a perspective, cross sectional view of a disconnect of the rear cover arm of FIG. 9A.

FIG. 10 is a side view of an expanding bow of the trailer of FIG. 1.

FIGS. 11A and 11B are enlarged views of one end of the expanding bow of FIG. 10 in retracted (11A) and extended (11B) positions.

FIG. 12 is an enlarged view of one end of the expanding bow of FIG. 10 in an extended position.

FIG. 13A is an elevation view of an assist mechanism attached to a rear end of the trailer.

FIG. 13B is an enlarged view of the assist mechanism of FIG. 13A in an uncoupled and coupled state.

FIG. 13C is a perspective view of the assist mechanism of FIG. 13B.

FIGS. 14A-14D are enlarged, cross sectional views of the assist mechanism of FIG. 13A.

FIG. 15 is an elevation view of the trailer front end panel showing the front cover arm and tarp in a retracted position.

FIG. 16 is an elevation view of the trailer front end panel showing the front cover arm and tarp in a deployed position.

### DETAILED DESCRIPTION OF THE PREFERRED EMBODIMENT

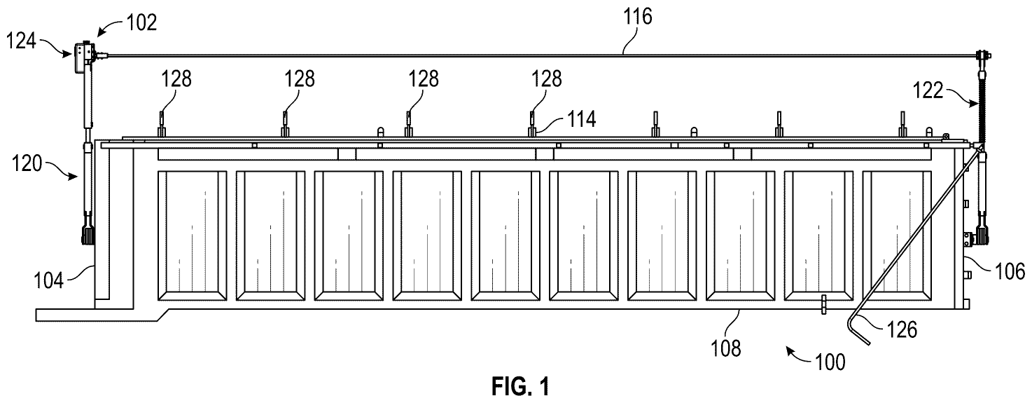

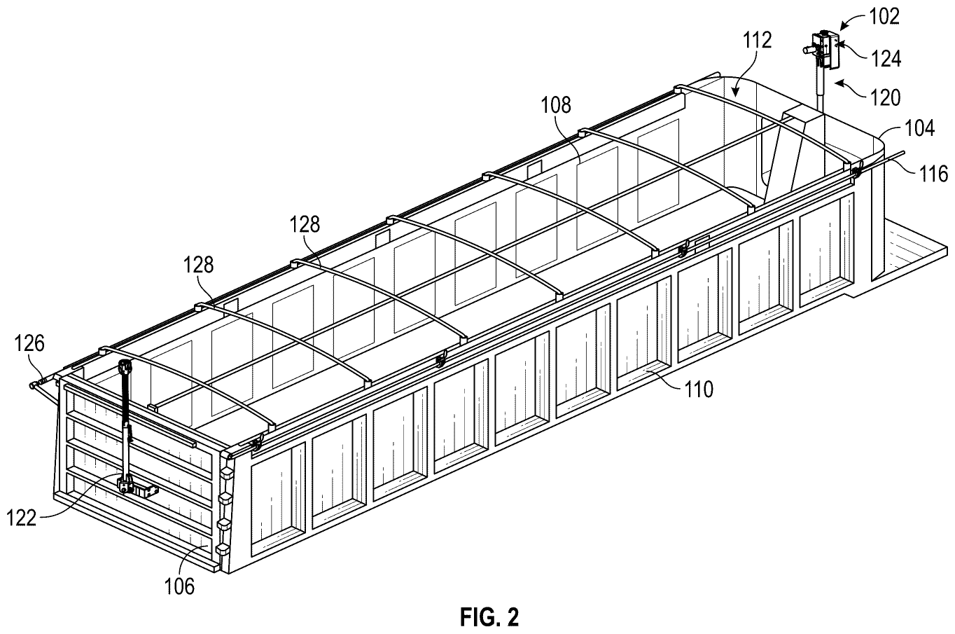

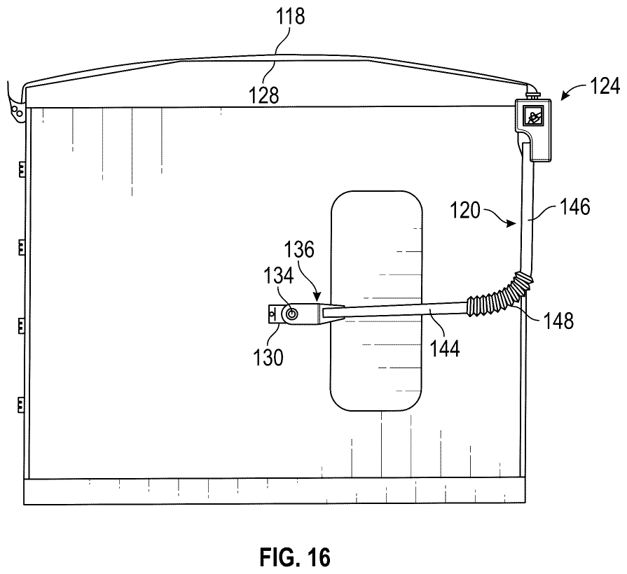

Referring now to the drawings, there is illustrated in FIGS. 1 and 2 is a trailer 100 having a cover drive system 102 attached to the trailer 100. The trailer 100 has a front end panel 104, a rear end panel 106, a first longitudinally extending sidewall 108, a second longitudinally extending sidewall 110, and an open top 112. The first longitudinally extending sidewall 108 and the second longitudinally extending sidewall 110 extend between the front end panel 104 and the rear end panel 106. The trailer 100 has a plurality of tarp rests 114 that support a towel bar 116 and tarp 118 in a stowed condition as illustrated in FIG. 15. The tarp 118 is wrapped around the towel bar in the stowed condition and payed out across the open top 112 in a deployed condition, as shown in FIG. 16. The cover drive system 102 includes a front cover arm 120, a rear cover arm 122, a drive system 124, the towel bar 116, a manual cover mechanism 126, and a plurality of bow assemblies 128.

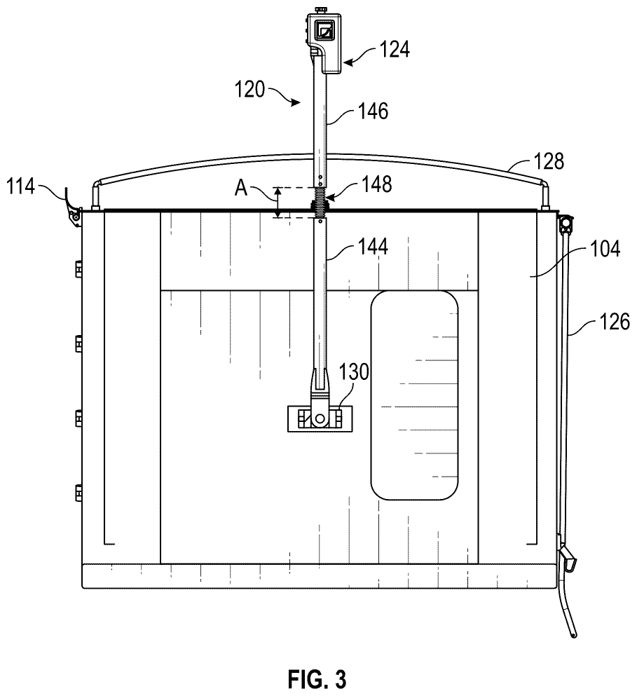

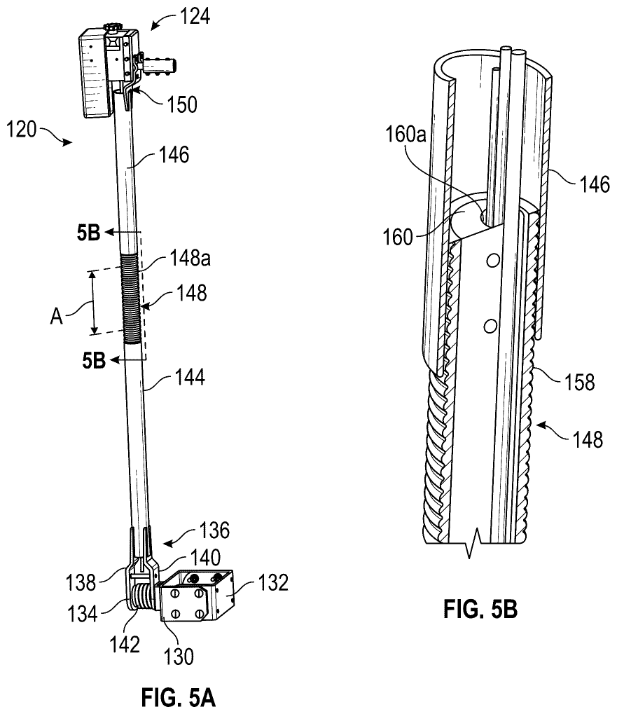

Referring now to FIGS. 3 and 5, the front cover arm 120 is attached to the front end panel 104 of the trailer 100 between the first and second sidewalls 108, 110, respectively. In the illustrated embodiment, the front cover arm 120 is attached to the center of the front end panel 104 of the trailer 100; however, the front cover arm 120 may be attached at any location in the panel 104. In the illustrated embodiment, the front cover arm 120 includes a front pivot bracket 130 attached to a front mounting bracket 132 that is supported on the front end panel 104. As shown in FIG. 5, the front pivot bracket 130 is attached to the front mounting bracket 132 by a plurality of fasteners, and a front pivot 134 extends from the front pivot bracket 130. The front pivot 134 is configured to pivotally support the front cover arm 120 for pivotal movement of the cover arm from one sidewall to the other sidewall. The front cover arm 120 includes an arm attachment bracket, shown generally at 136, that pivotally attaches to the front pivot 134. In the illustrated embodiment, the front pivot mounting bracket 136 has a first flange 138 and a second flange 140 that captures a front assist spring 142 therebetween. The front assist spring 142 provides an assist force that biases the front cover arm, towel bar, and tarp into the deployed position, as shown in FIG. 16.

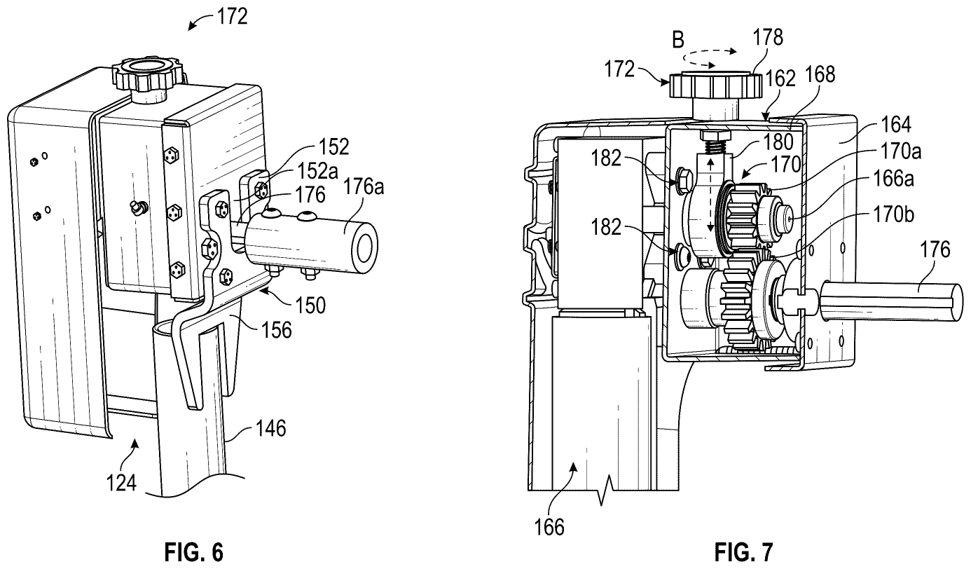

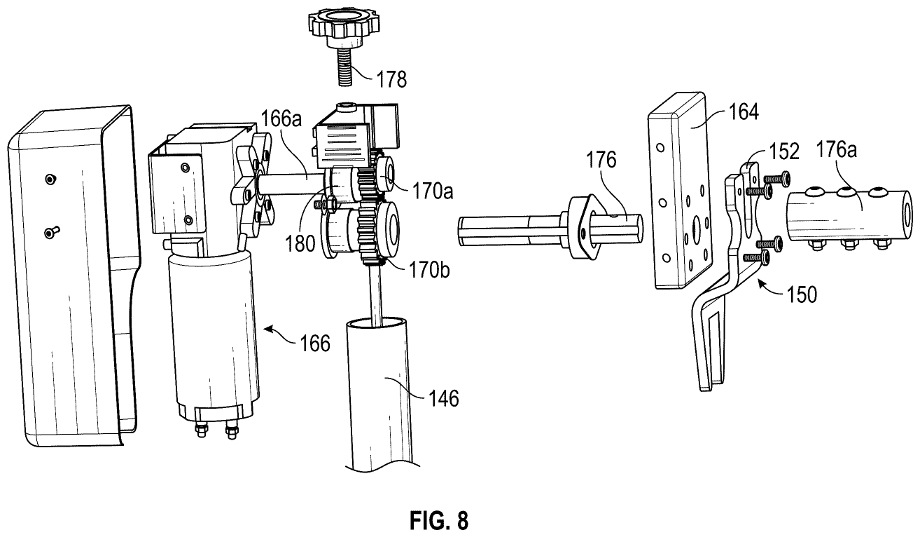

The front cover arm 120 includes a first section 144 and a second section 146 connected together by a flex member 148. The flex member 148 accommodates relative movement between the first and second sections as the cover arm 120 rotates from the stowed to deployed positions, as shown in FIGS. 15 and 16. The first and second sections 144 and 146 are illustrated as tubular elements that are stiff and configured to support the drive system 124 relative to the front end panel. The first section 144 connects to the arm attachment bracket 136 and may be permanently or removably attached thereto. The second section 146 is connected to the drive system 124 by a drive mounting bracket 150. As shown in FIGS. 6 and 7, the drive mounting bracket 150 includes a flange 152 that bolts to a gearbox 154 of the drive system and an arm mount 156 that attaches to the first section 144. The flange 152 includes a release slot 152a that permits the drive system to be removed from the arm. The slot 152a and bolted connection permits the drive system 124 to be removed without removing the entire front cover arm 120 from the trailer.

The flex member 148 connects the first and second sections 144 and 146 together and comprises an outer sleeve 158 illustrated as a corrugated tube. In the illustrated embodiment, the outer sleeve 158 is made from a corrugated plastic tube, such as a polyethylene or polypropylene tube, though any flexible polymer or bendable metal element may be used. The outer sleeve 158 may be filled with a foam material forming a core 160 that assists in providing stability to the outer sleeve as the first section 144 flexes relative to the second section 146 during movement of the front cover arm. The core 160 also maintains the cross section of the outer sleeve 158, shown as a generally circular cross section of a cylindrical tubular section, as the arm flexes. This support prevents the outer sleeve 158 from collapsing during movement so that the tarp rolls evenly from the stowed to deployed positions, as shown in FIGS. 15 and 16. In one embodiment, the core 160 is formed from a flexible foam material such as a polyurethane foam or latex foam that may be a minimally expanding or exhibit a high expansion rate. In another embodiment, the core 160 may be a poured urethane material having a durometer of approximately 80 on a Shore A scale. In another embodiment, the durometer may be in a range of about 60 Shore A to about 80 Shore A. Alternatively, the durometer may be in a range of about 70 Shore A to about 90 Shore A. As an example, a durometer of about 80 Shore A may exhibit a flexibility similar to a sturdy leather belt. An access port 160a may extend through the core 160 to permit an electrical harness or other structures to pass from the trailer to the drive system. An outer jacket or cover 148a may extend over the flex member 148 and attach to the first and second sections 144 and 146 to prevent debris intrusion. In the illustrated embodiment, the outer jacket 148a is a convoluted rubber or silicone boot though other coverings, such as straight-walled boots may be used.

As the front cover arm 120 moves from the stowed position of FIG. 15 to the deployed position of FIG. 16, the flex member 148 permits the drive system 124 to pay out the tarp 118 against the bows 128. The weight of the drive system 124 is sufficient to maintain contact of the tarp to the bows during deployment and overcomes the flexure resistance of the flex member such that the front cover arm may appear to be bent during deployment or retraction. In one embodiment, a length “A” of the exposed, articulatable, flex member may be about 12 inches. Alternatively in one embodiment, the length “A” may be in a range of about 8 inches to about 16 inches. In yet another embodiment, the length “A” may be in a range of about 12 inches to about 15 inches. End portions of the flex member are attached to the first and second sections, 144 and 146 respectively. The relative lengths of the first and second sections, 144 and 146, are adjusted so that the second section and flex member are proximate to the outer profile of the trailer, and preferably within the 102 inch trailer width limit in one embodiment.

Referring now to FIGS. 5A-7, the illustrated drive system 124 includes a transmission 162, a drive system mounting cover 164, and a drive motor 166. The transmission 162 is encased in transmission housing 168 that supports a plurality of gears 170 and a disconnect assembly 172. The drive motor 166, illustrated as a 90 degree, worm gear and drive motor assembly, is coupled to the transmission 162 to power to a tarp drive output shaft 176. It should be understood that any type of drive motor may be used, with or without a worm gear drive interface. The drive motor 166 is coupled to a drive gear 170a and the tarp drive output shaft 176 is coupled to a driven gear 170b that is selectively engaged with the drive gear. Although shown as a drive gear and driven gear, the plurality of gears may be any number desired to provide, for example, a rotation direction change or a torque multiplication (or reduction) factor. The tarp drive output shaft 176 is shown attached to a towel bar coupling 176a that engages the towel bar 166 for rotation. The disconnect assembly 172 includes a disconnect actuator 178, illustrated as a knob and threaded shaft assembly, that engages a disconnect collar 180. The disconnect actuator 178 may alternatively be a powered element that moves the disconnect collar. The disconnect collar 180 includes a support bearing coaxially oriented around the drive motor output shaft 166a that extends through the drive gear 170a. As the disconnect actuator 178 is rotated in a first direction (such as the counterclockwise rotation of arrow B), the disconnect collar 180, along with the drive motor 166 and the drive gear 170a, is drawn away from engagement with the driven gear170b, as shown by arrow C. In the illustrated embodiment, attachment apertures 182 are elongated to permit the drive motor to slide relative to the transmission housing 168 to which it is connected. This permits the motor to be decoupled from the output shaft and towel bar in the event of a motor or electrical failure. Thus, manual operation of the tarp may be effected without necessitating removal of the motor.

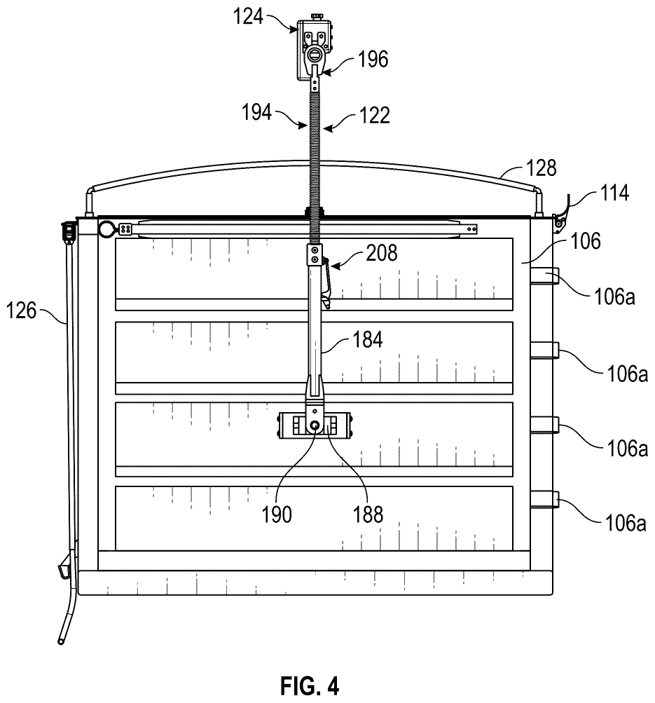

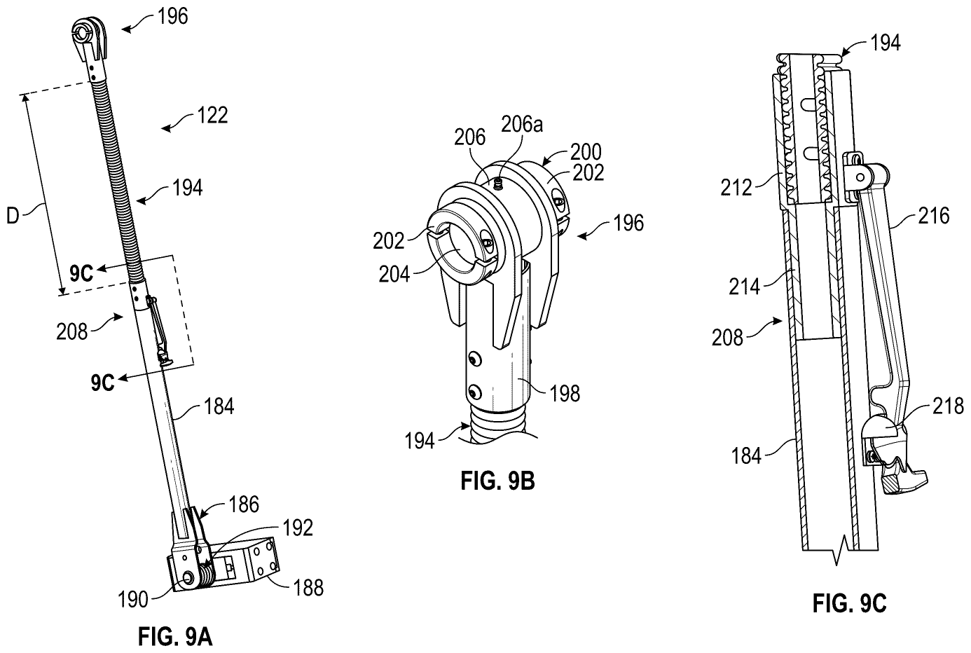

Referring now to FIGS. 4 and 9A-9C, the rear cover arm 122 is illustrated. The rear cover arm 122 is attached to the rear end panel 106 of the trailer 100. In certain embodiments of the trailer 100, the rear end panel may be configured as a hinged door supported by a plurality of hinges 106a. In the illustrated embodiment, the rear cover arm 122 is attached to the center of the rear end panel 106 of the trailer 100; however, the rear cover arm 122 may be attached at any location on the rear end panel 106. In certain embodiments of the trailer 100, the rear cover arm may be omitted or provided as an optional assist mechanism. As will be discussed below, in embodiments without the rear cover arm, an assist spring mechanism is provided. The front cover arm 120 and the rear cover arm 122 are generally aligned and define a rotational axis of the towel bar 116. The rear cover arm 122 includes a first section 184 connected by an arm attachment bracket 186 to a rear pivot bracket 188. The arm attachment bracket 186 and rear pivot bracket 188 are similar to arm attachment bracket 136 and front pivot bracket 130 described above. The rear pivot bracket 188 includes a rear pivot 190 that extends therefrom to pivotally connect the rear cover arm 122 to the rear end panel 106. A rear assist spring 192 may be provided similar to front assist sprig 142. The rear cover arm 122 includes a flex member 194 that connects to a towel bar coupler 196, as shown in FIGS. 9A and 9B. In one embodiment, the flex member 194 may be similarly configured to the flex member 148 with an outer corrugated tube structure and an inner urethan core, as described above. Alternatively, the flex member 194 may only comprise a corrugated polymer tube. The flex member 194 has a length “D” that is longer than the flex member 148 length “A. ” In one embodiment, the length “D” may be in a range of about 37 inches to about 38 inches. In an alternative arrangement, the length “D” may be in a range of about 34 inches to about 44 inches. The added length permits the rear cover arm 122 to move with the rear end panel 106 when configured as a hinged or open-able structure such as a tailgate or door.

As shown in FIG. 9B, the towel bar coupler 196 includes a mounting tube 198 that attaches to the flex member 194. A collar 200 includes spaced-apart clamp rings 202 that attach to the towel bar 116 and a bushing 204 extending therebetween. A collar mount 206 supports the clamp rings 202 and bushing 204 for rotation and is fixed to the mounting tube 198. A lubrication fitting or zerk 206a may be provided. Referring to FIG. 9C, a rear arm disconnect coupling, shown generally at 208, permits the rear cover arm 122 to be easily separated between the towel bar coupler 196 and the rear end panel 106 of the trailer. This separation capability permits access to or operation of the rear end panel 106 without necessitating disengagement of the towel bar from the rear cover arm. The rear arm disconnect coupling 208 includes a disconnect collar 210 that has a flex member mount 212 that attaches to the flex member 194 and a pilot 214 that engages and aligns with the first section 184. The flex member mount 212 supports one part of a lockdown strap 216, illustrated as a rubber tie down pivotally mounted to the flex member mount. It should be understood that the lockdown strap 216 may be any type of releasable connection such as, for example, an over-center clamp or collapsible collet, configured to secure the disconnect collar to the first section. The illustrated lockdown strap 216 engages a strap bracket 218 mounted on the first section 184.

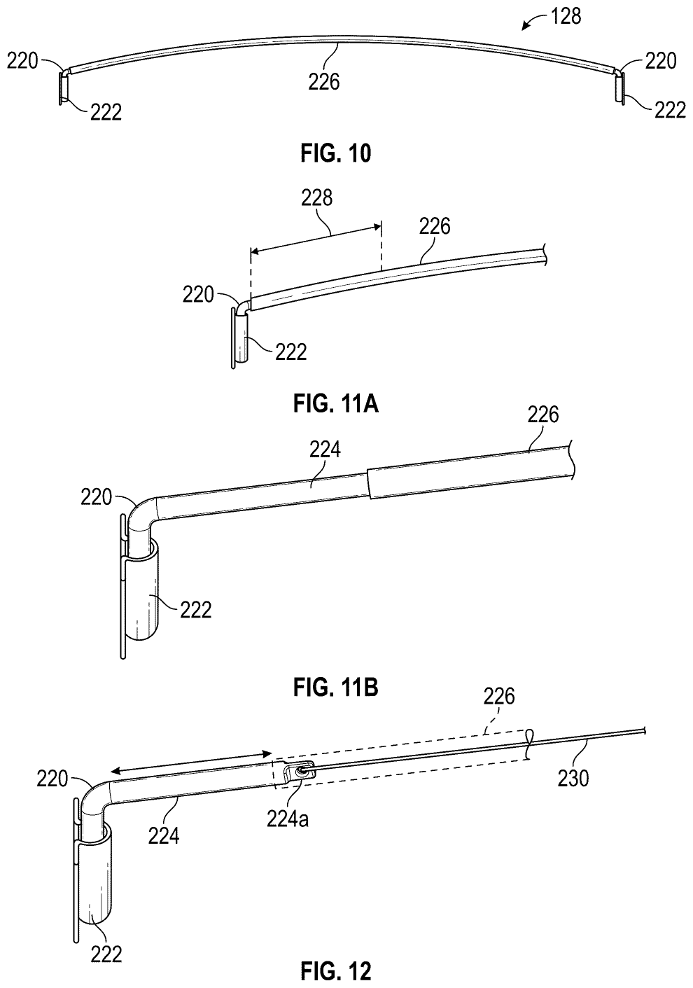

Referring now to FIGS. 10-12, there is illustrated the tarp bow assembly 128 that spans the side walls 108 and 110 to support the tarp 118 in the deployed state over the trailer open top. The tarp bow assembly 128 is length adjustable and can accommodate relative movements of the side walls 108 and 110 during operation and hauling activities. The tarp bow assembly 128 includes opposed angle struts 220 received in bow anchors 222 that are connected to portions of the trailer side walls. The angle strut 220 has a slide arm 224 that telescopically engages a cross tube 226 in a slip fit arrangement. In one embodiment, a telescoping interface 228 of the cross tube 226 and the slide arm 224 is configured as a generally straight section. Alternatively, the telescoping interface 228 may be any geometry that permits relative movement between the slide arm 224 and cross tube 226. In certain configurations, the slide arm and cross tube may be circular or oval. In other configurations, alternative geometries, such as square, rectangular, triangular, and the like may be used.

As shown in FIG. 12, in certain configurations opposing slide arms 224 each terminate in an anchor 224a that connects to a cross tie 230. In certain embodiments, the cross tie 230 may be an elastomeric member such as, for example, a bungie cord or spring. Alternatively, the cross tie 230 may be a more rigid member such as a cable having sufficient slack to permit movement of the side walls relative to each other. The cross tie 230 extends through the cross tube 226 and assists in maintaining the tarp bow assembly 128 together during operation to support the deployed tarp 118.

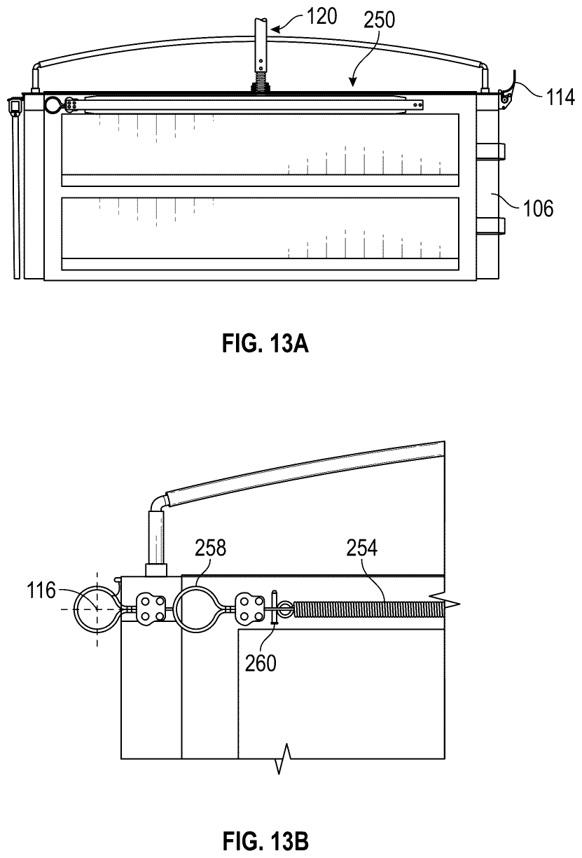

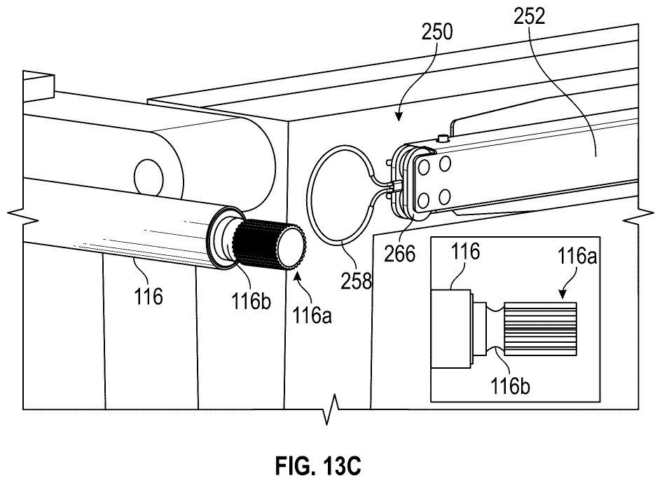

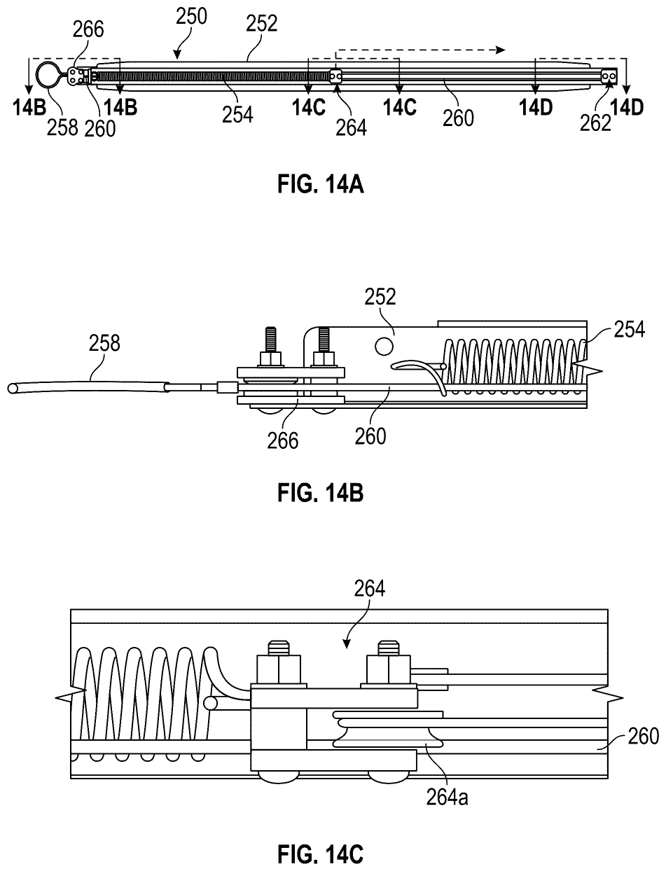

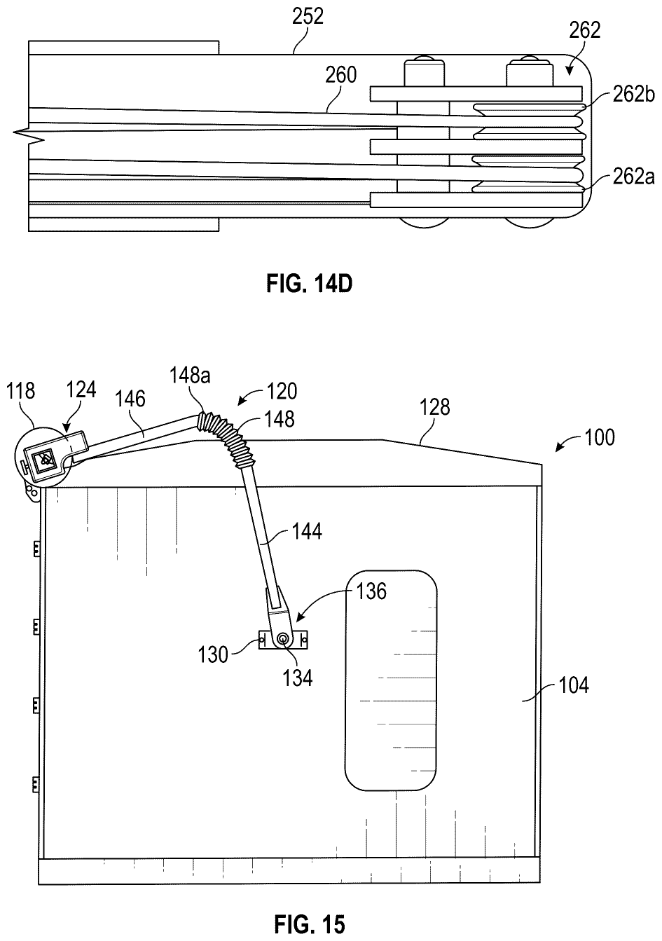

Referring now to FIGS. 13A and 13B, a tarp tensioner 250 is shown attached to the rear end panel 106 of the trailer. The tarp tensioner 250 includes a housing 252 that contains a tensioning assist spring 254 and tension multiplier, shown generally at 256 in the form of a block-and-tackle pulley and cable system. The housing is fixed to the trailer rear end panel 106. The tension multiplier 256 is shown in detail in FIGS. 14A-14D. A load loop 258 extends from the tarp tensioner housing 252 and connects to a manual drive end 116a of the towel bar 116. The manual cover mechanism 126, illustrated as a conventional crank and u-joint assembly, connects to the manual drive end 116a, configured as a splined shaft as shown in FIG. 13C. In one embodiment, a groove 116b is provided to retain the load loop 258 onto the towel bar 116. The load loop 258 is connected to a return cable 260 that is threaded (or roved) through two blocks, shown as a fixed block 262 and a moving block 264. The fixed block 262 is anchored to the housing and is shown supporting two pulleys, 262a and 262b. The moving block 264 includes a single pulley 264a and is connected to the tensioning assist spring 254 at one end. The other end of the tensioning assist spring 254 is attached to the housing 252. As the load loop 258 and return cable 260 are extended from the housing, the moving block 264 is retracted towards the fixed block 262 and causes the tensioning assist spring 254 to extend, creating a force that acts to retract the load loop 258. The load loop 258, connected to the towel bar, follows the movement of the towel bar and tarp assembly over the bows. A guide roller set 266 permits the return cable to follow the bow profile without becoming tangled or otherwise dislodged from the tarp tensioner 250 during a tarp deployment operation. When the tarp is to be retracted, the tensioning force in the return cable assists in drawing the towel bar back and keeping the tarp and towel bar traveling, generally over the bows 128.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A tarp cover system comprising:
a front cover arm having a first section joined to a second section by a flex member;
a drive system supported by the second section of the front cover arm, the drive system having a drive motor operatively connected to a transmission, the transmission including a disconnect assembly that selectively engages or disengages a transmission output from a transmission input; and
a towel bar engaging the transmission output to deploy or retract a trailer tarp cover relative to a trailer body.

2. The tarp cover system of claim 1 wherein the transmission includes a disconnect actuator engaging a disconnect collar configured to separate a drive gear from a driven gear within the transmission.

3. The tarp cover system of claim 2 wherein the disconnect actuator includes a threaded shaft engaged with the disconnect collar.

4. The tarp cover system of claim 1 wherein the first section includes a flange that secures the drive system thereto, the drive system being axially moveable relative to the flange and detachable from the flange independently of the front cover arm.

5. The tarp cover system of claim 4 wherein the flange engages a transmission housing that supports the drive motor.

6. The tarp cover system of claim 1 wherein the flex member includes a corrugated outer sleeve filled with a core material.

7. The tarp cover system of claim 6 wherein the corrugated outer sleeve is formed from one of polyethylene or polypropylene material and the core material is a flexible foam material formed from one of a urethane or a latex foam having a durometer in a range of about 70 Shore A scale to about 90 Shore A scale.

8. The tarp cover system of claim 6 wherein the core material includes an access port extending therethrough, the access port configured to accommodate an electrical harness.

9. The tarp cover system of claim 1 wherein a rear cover arm engages the towel bar, the rear cover arm including a first section and a second section connected together by a flex member.

10. The tarp cover system of claim 9 wherein the rear arm includes a disconnect coupling configured to permit the first section to be removed from the second section.

11. The tarp cover system of claim 10 wherein the disconnect coupling is attached to the rear cover arm flex member and includes a disconnect collar configured to align and attach to the first section and a lockdown strap connected between the disconnect collar and the first section.

12. The tarp cover system of claim 1 wherein a tarp tensioner is configured to engage a manual drive end of the towel bar, the tarp tensioner comprising a tension assist spring and a tension multiplier.

13. The tarp cover system of claim 12 wherein the tension multiplier is configured as a block-and-tackle pulley and cable system having a fixed block attached to a housing and a moving block connected to the assist spring, a return cable is attached to the manual drive end at a first end, roved through the fixed and moving blocks, and attached to the moving block at a second end.

14. The tarp cover system of claim 1 wherein a plurality of length-adjustable bows are attached to side walls of the trailer body and accommodate relative movement of the side walls, the length-adjustable bows support the tarp covering between a retracted position and a deployed position.

15. The tarp cover system of claim 14 wherein the length-adjustable bows each include angle struts attached to the trailer side walls, the angle struts have slide arms that engage a cross tube over a telescoping interface permitting relative movement between the slide arms and the cross tube.

16. The tarp cover system of claim 15 wherein the cross tube is hollow and the telescoping interface is configured as a generally straight section, the slide arms engage a cross tie that extends through the cross tube.

17. A trailer and tarp cover system comprising:
a front cover arm mounted to a front end panel of the trailer and having a first section joined to a second section by a front arm flex member;
a drive system supported by the second section of the front cover arm, the drive system having a drive motor operatively connected to a transmission, the transmission including a disconnect assembly that selectively engages or disengages a transmission output from a transmission input;
a rear cover arm mounted to a rear end panel of the trailer, the rear cover arm including a first section and a second section connected together by a rear arm flex member, the rear arm flex member attached to the first section by a disconnect coupling that includes a disconnect collar configured to align with the first section and a lockdown strap connected between the disconnect collar and the first section; and
a towel bar connected between the front cover arm and the rear cover arm and configured to deploy or retract a trailer tarp cover relative to the trailer.

18. The trailer and tarp cover system of claim 17 wherein a plurality of length-adjustable bows are attached to side walls of the trailer and accommodate relative movement of the side walls, the length-adjustable bows support the tarp covering between a retracted position and a deployed position, the length-adjustable bows include angle struts attached to the trailer side walls, the angle struts have slide arms that engage a cross tube over a telescoping interface permitting relative movement between the slide arms and the cross tube.

19. A trailer and tarp cover system comprising:
a front cover arm mounted to a front end panel of the trailer and having a first section joined to a second section by a front arm flex member;
a drive system supported by the second section of the front cover arm, the drive system having a drive motor operatively connected to a transmission, the transmission including a disconnect assembly that selectively engages or disengages a transmission output from a transmission input;
a towel bar connected to the front cover arm and having a manual drive end extending toward a rear end panel of the trailer, the towel bar configured to deploy or retract a trailer tarp cover relative to the trailer; and
a tarp tensioner mounted to the rear end panel of the trailer and configured to engage the manual drive end of the towel bar, the tarp tensioner comprising a tension assist spring and a tension multiplier configured as a block-and-tackle pulley and cable system having a fixed block attached to a housing and a moving block connected to the assist spring, a return cable is attached to the manual drive end at a first end, roved through the fixed and moving blocks, and attached to the moving block at a second end.

20. The trailer and tarp cover system of claim 19 wherein a plurality of length-adjustable bows are attached to side walls of the trailer and accommodate relative movement of the side walls, the length-adjustable bows support the tarp covering between a retracted position and a deployed position, the length-adjustable bows include angle struts attached to the trailer side walls, the angle struts have slide arms that engage a cross tube over a telescoping interface permitting relative movement between the slide arms and the cross tube.
